(19) United States
(12) Patent Application Publication
(10) Pub. No.: US 2020/0390284 A1
(43) Pub. Date: Dec. 17, 2020

(54) SINGLE MOLDED DEVICE FOR SHREDDING AND STORING HERBS

(71) Applicants: Jeremy Griffin, Lancaster, CA (US); Jacob Griffin, Lancaster, CA (US)

(72) Inventors: Jeremy Griffin, Lancaster, CA (US); Jacob Griffin, Lancaster, CA (US)

(21) Appl. No.: 16/441,667

(22) Filed: Jun. 14, 2019

(51) Int. Cl. A47J 42/04; A47J 43/04

(52) U.S. Cl. CPC A47J 42/04; A47J 43/04

(57) ABSTRACT

A novel device for preparing fresh herbs and corresponding method are disclosed. The device includes a cap, a body for receiving the cap, and a hinge coupling the cap to the body. The cap, body, and hinge are each preferably comprised of plastic and manufactured such that the cap, body, and hinge are of one-piece construction. The cap includes an interior having shredding means. The body includes a chamber having shredding means. Fresh herbs may be placed within the chamber to be shredded after the cap is separated from the body. The hinge is preferably configured to be broken to permit the cap to be separated from the body. The device may also include a latch mechanism for hinging the cap back onto the body and for keeping the cap held onto the body once the device is no longer in use.

### BACKGROUND

The present disclosure relates generally to a device to prepare fresh herbs by defoliating leaves from the stem of the herb, shredding or tearing the leaves to maximize the secretion of the essential oils contained therein and the aromatic nature of the herbs, and then storing any unused herbs.

### SUMMARY

One exemplary embodiment of the disclosed subject matter is a single molded device having a cap, a body for receiving the cap, and a hinge coupling the cap to the body. The cap, body, and hinge are each preferably comprised of plastic and manufactured such that the cap, body, and hinge are of one-piece construction. The cap includes an interior having shredding means. The body includes a chamber having shredding means. Fresh herbs may be placed within the chamber to be shredded after the cap is separated from the body.

The hinge is configured to be broken to permit the cap to be separated from the body. To do so, the hinge includes a first hinge component extending away from the cap, and a second hinge component extending away from the body. The first hinge component and the second hinge component may each include breakaway tabs.

The device preferably also includes a latch mechanism for hinging the cap back onto the body and for keeping the cap held onto the body once the device is no longer in use. The latch mechanism may include a latch extending away from the body, and a peg extending from the cap. The latch includes a hole configured to receive the peg.

Both the cap shredding means and the body shredding means are comprised of sharp protrusions. The protrusions of the cap shredding means are preferably conically shaped protrusions. The body shredding means may be pentrahedrally shaped protrusions.

Another exemplary embodiment of the disclosed subject matter is a method of preparing fresh herbs. The method steps include holding a device including a cap, a body for receiving the cap, and a hinge coupling the cap to the body. The cap, body, and hinge are in one piece. The cap includes an interior having shredding means. The body includes a chamber having shredding means. The user then breaks the hinge previously coupling the cap to the body such that the cap is now separate from the body. Fresh herbs are placed within the chamber. The user then positions the cap so the interior of cap is located opposite the chamber. The cap is guided into the body while applying rotational pressure to cause the herbs to come in contact with each of the shredding means to shred the herbs. The user continues to rotate and shred the herbs until a desired degree of fineness is achieved.

The method may further including pulling the cap away from body after the desired degree of fineness is achieved, storing any residual herbs inside the body, and placing the cap onto the body to keep the residual herbs stored within the body.

The device may include a latch mechanism for hinging the cap back onto the body and for keeping the cap held onto the body once the device is no longer in use. The latch mechanism includes a peg extending from the cap, and a latch extending away from the body, wherein the latch has a hole configured to receive the peg.

The hinge preferably includes a first hinge component extending away from the cap, and a second hinge component extending away from the body. Each hinge component may include breakaway tabs.

Both the cap shredding means and the body shredding means are sharp protrusions. The protrusions of the cap shredding means are preferably conically shaped. The body shredding means preferably include pentrahedrally shaped protrusions.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a top perspective view of an exemplary embodiment disclosed herein showing the cap open and not yet detached from the body of the device;

FIG. 2 is a bottom perspective view of the embodiment shown in FIG. 1;

FIG. 3 is a top perspective view of the embodiment seen in FIG. 1 showing the single molded device now separated into two pieces, i.e., after the hinge originally attaching the cap to the body of the device has been broken to begin use of the device;

FIG. 4 is a bottom perspective view of the embodiment seen in FIG. 3 showing how the device reverts back to a hinged cap arrangement via the latch mechanism;

FIG. 5 is a top perspective view of the embodiment seen in FIG. 1 showing the cap held into place via the latch mechanism after using the device; and

FIG. 6 is a bottom perspective view of the device seen in FIG. 4.

### DETAILED DESCRIPTION

Dried herbs for culinary or other uses typically come packaged in a glass container with a screw-top lid, as commonly seen in grocery store aisles. These herbs usually are defoliated, i.e., the leaves have been removed from the stem, before packaging. When ready to use, preparation of the dried herb preferably requires grinding or crushing to release any remaining, naturally occurring oils and essences of the herb. Conventional grinders having metallic spinning blades within a housing and a top to the housing may be used for such preparation.

Fresh herbs for culinary or other uses typically do not come packaged or prepared for use in any manner, other than a rubber band that may wrap around the herbs, such as with parsley or the like in the grocery store. When ready to use, preparation of the fresh herbs typically involves removing the leaves from any stems, and then shredding or tearing the leaves to maximize the secretion of the essential oils contained therein and the aromatic nature of the herbs. Contrary to dried herbs, fresh herbs should not be prepared with metallic blades. Doing so will create oxidation between the ferrous of the steel and the oils of the fresh herbs. Instead, the leaves should be torn or shredded by hand and/or with a shredding device that does not use metal. Conventional shredding devices require two separate pieces, e.g., a top and a bottom, each having some form of shredding means. The leaves are placed inside the two pieces, which are then rotated in different directions to permit the shredding means to tear the herbs. Any unused fresh herbs are then stored in a container. The top and bottom pieces are typically made of plastic using two separate molds, adding to the cost of manufacturing.

Accordingly, a single molded defoliating, shredding, and storage device solving these and other problems is desired.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

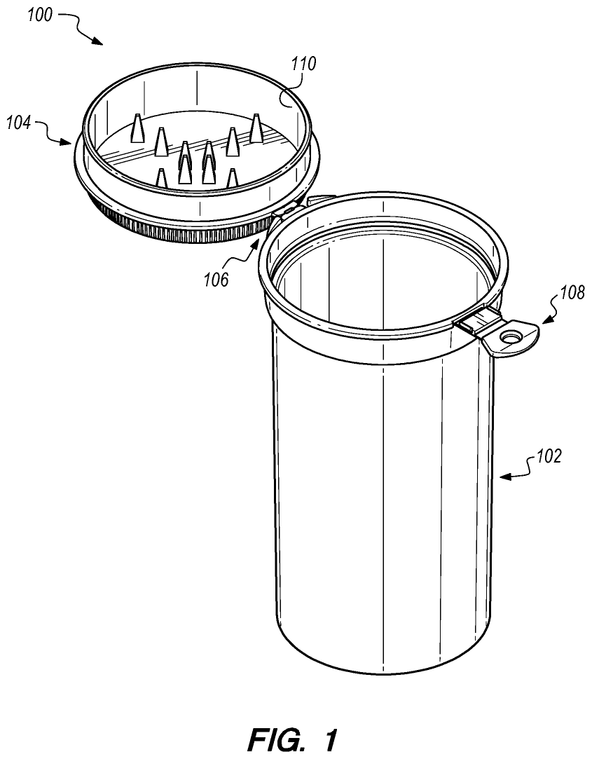

FIGS. 1-6 illustrate one such exemplary embodiment of a novel storage device 100 disclosed herein. The device 100 includes a cylindrical body 102 coupled to a cap 104 via hinge 106. The device 100 also preferably includes a latch mechanism to revert the device 100 back to a hinged cap arrangement and to help keep cap 104 closed onto body 102 once the hinge 106 has been broken to begin use.

As seen in FIG. 1, the device 100 is one-piece. Device 100 is preferably constructed of plastic that has been injection molded in one shot, creating a single molded defoliating, shredding, and storage device. As discussed above, it is technically impossible to have a one-piece working shredder since two separate counter-rotating pieces are required for use. Thus, a single molded/one-piece shredding device is counter-intuitive. In a similar vein, it is equally counter-intuitive to break a device before use. Here, the hinge 106 of the device 100 must be broken before use, as discussed in detail below. Accordingly, for at least these reasons, the invention set forth herein is useful, novel, and non-obvious over known devices.

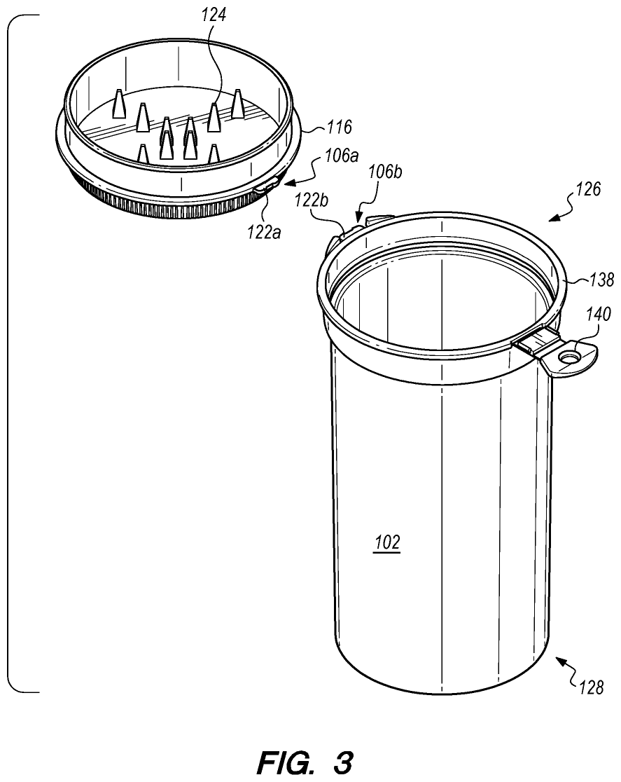

Turning in detail to the drawings, cap 104 has an interior 110 and an exterior 112. Ribbing 114 may be disposed about the exterior 112 of cap 104. The cap 104 may also have an overhang 116 disposed about the exterior 112. A channel 118 is preferably cut into the exterior 112. The channel 118 is adapted to receive latch 108 of the body 102. A peg 120 preferably extends away from the exterior 112 and preferably does so from a central location within channel 118. A hinge component 106a extends away from exterior 112 of cap 104, as best seen in FIG. 3. The hinge component 106a is part of the hinge 106 illustrated in FIG. 1. This hinge 106 is meant to broken into two pieces. The break is made easy by way of breakaway tabs 122a, which contact complementary breakaway tabs 122b of hinge component 106b extending away from body 102.

Cap 104 also has shredding means 124 extending away from the interior 110. Shredding means 124 are sharp protrusions, each of which preferably has sloped sides. In particular, the protrusions may be conical, pentrahedrally shaped, or tetrahedrally shaped, as disclosed in U.S. Pat. No. 8,220,732, incorporated by reference as if set forth fully herein. Such shapes facilitate optimal shredding action rather than a grinding or squeezing action that would harm the herbs.

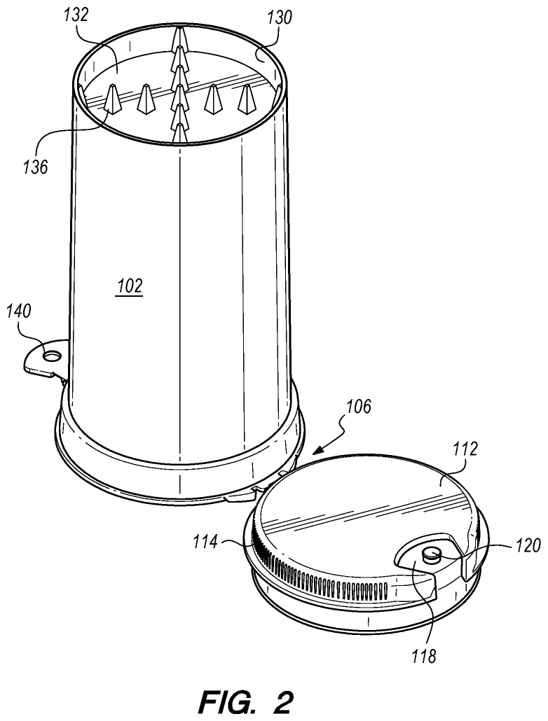

Body 102 is preferably cylindrical in shape from top 126 to opposing bottom 128. The body 102 may be comprised of arcuate side walls 130 and a bottom wall 132 whereby body 102 forms a tube with a closed bottom 128 and an open top 126. As best seen in FIG. 2, the side walls 130 extend further than the junction of the bottom wall 132 and side walls 130. Doing so creates an interior defoliating and shredding chamber 132 about the bottom 128 of body 102. FIG. 2 illustrates shredding means 136 may be disposed within chamber 132. In particular, shredding means 136 may extend from the bottom wall 132 away from the body 102. These shredding means 136 are configured to complement the biasing action of shredding means 124 in the cap 104.

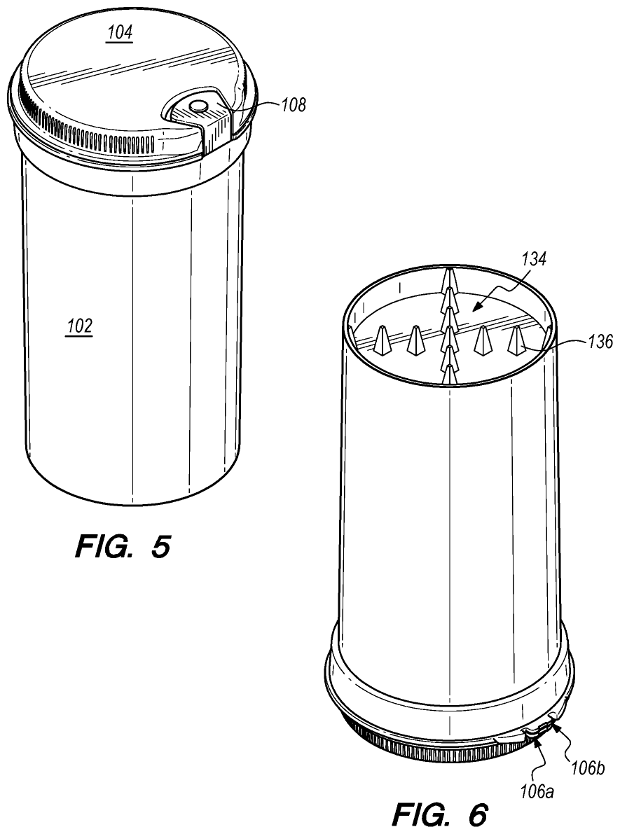

The body 102 may also have a ridge 138 extending therefrom. The ridge 138 is configured to engage the overhang 116 of the cap 104 when the device 110 is not in use, as best seen in FIGS. 5-6.

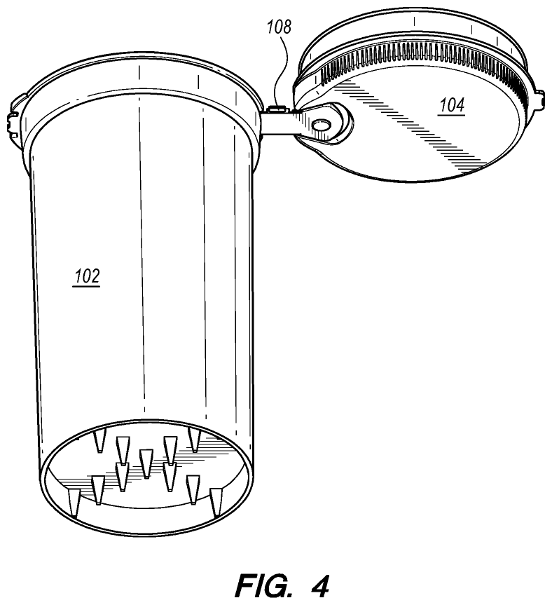

The device 100 preferably has latch means to revert the device 100 back to a hinged cap arrangement (see FIG. 4) and to help keep cap 104 closed onto body 102 once the device 100 is no longer in use (see FIGS. 5-6). The latch means preferably comprises latch 108 with its latch hole 140 configured to receive peg 120 of the cap 104. Other known latch mechanisms may be employed.

Body 102 also has hinge component 106b extending away from the body 102. Hinge component 106b includes its breakaway tabs 122b that complement hinge component 106a with its breakaway tabs 122a. The tabs 122a, 122b allow the hinge 106, which connects the cap 104 to the body 102 before the device 100 is used, to be broken into two pieces to allow the device 100 to be operated.

In operation for the first time, the user begins with a single molded device 100, as seen in FIG. 1, but the cap 104 will most likely be seated on the body 102 with the latch 108 and peg 120 keeping the cap 104 in place. As a first step, the user pulls the latch 108 away from the peg 120. Next, the user squeezes the body 102 near its top 126 and preferably under the ribbing 114 of the cap 104. Squeezing is done until the cap 104 pops off the body 102. This configuration is illustrated in FIGS. 1 and 2. Next, the user needs to break the device 100 to continue to use it. In particular, the user must break hinge 106 coupling the cap 104 to the body 102. The user does so by rotating the cap 104 and/or body 102, or otherwise moving the two items, until the breakaway tabs 122a, 122b break off from one another. This configuration is illustrated in FIG. 2.

Next, the user decides how much fresh herbs to prepare. The desired quantity is placed in the interior 110 of the cap 104 and/or the defoliating and shredding chamber 134 of body 102. The user then positions the cap 104 so the interior 110 of cap 104 is located directly opposite chamber 134. The user brings the cap 104 into proximal contact with lower end of body 102, thereby containing the herb to be prepared, desirably completely within the chamber 134. The user begins a rotational circumferential action of the cap 104 onto the body 102 using a slight pressure bringing the two pieces 102, 104 into contact. The user circumferentially guides the cap 104 around the lower end of body 102 while also rotating the actual cap 104, causing the herbs to come in contact with the shredding means 124, 136. The user, through gentle compressive and rotational pressure, condenses and thusly shreds the herbs, while completely containing the herbs in the chamber 134 until the interior 110 of cap 104 is in complete contact with the lower end of body 102. The user continues to rotate and shred the herb until the defoliation and the degree of fineness is achieved. At that time, the user pulls the cap 104 away from the body 102 and dumps out the prepared herbs for use as desired. Any remaining herb residue may then be stored in the interior of body 102, conserving the unused portion.

To revert the device 100 back to a hinged cap arrangement, the latch means is utilized. In particular, the latch 108 is moved toward the channel 118 until the peg 120 is seated within hole 140, as seen in FIG. 4 (showing the latch means acting as a secondary hinge). The cap 104 is then replaced on the top 126 of body 102, applying pressure until the overhang 116 engages the ridge 138, as seen in FIGS. 5-6. As illustrated there, the latch means also helps keep cap 104 closed onto body 102. When the user desires to prepare more herbs, the steps are repeated except for the step of breaking the hinge 106.

While certain embodiments have been described, the embodiments have been presented by way of example only and are not intended to limit the scope of the inventions. Indeed, the novel shredding and storage device and corresponding method described herein may be embodied in a variety of other forms. Furthermore, various omissions, substitutions, and changes in the form of the disclosed elements may be made without departing from the spirit of the inventions. The accompanying claims and their equivalents are intended to cover such forms or modifications as would fall within the scope and spirit of the inventions.

1. A single molded device for preparing fresh herbs, the device comprising:
a cap;
a body for receiving the cap; and
a hinge coupling the cap to the body;
wherein the cap, body, and hinge are comprised of plastic and manufactured such that the cap, body, and hinge are of one-piece construction;
wherein the cap includes an interior having shredding means,
wherein the body includes a chamber having shredding means,
whereby fresh herbs may be placed within the chamber to be shredded after the cap is separated from the body.

2. The device of claim 1, wherein the hinge is configured to be broken to permit the cap to be separated from the body.

3. The device of claim 2, wherein the hinge includes a first hinge component extending away from the cap, and a second hinge component extending away from the body, wherein the first hinge component and the second hinge component each include breakaway tabs.

4. The device of claim 1, further comprising a latch means including a latch extending away from the body.

5. The device of claim 4, wherein the latch means further includes a peg extending from the cap, and wherein the latch includes a hole configured to receive the peg.

6. The device of claim 1, wherein the cap shredding means include conical shaped protrusions.

7. The device of claim 1, wherein the body shredding means include pentrahedrally shaped protrusions.

8. A method of preparing fresh herbs, the method comprising:
holding a device including a cap, a body for receiving the cap, and a hinge coupling the cap to the body, wherein the cap, body, and hinge are in one piece, wherein the cap includes an interior having shredding means, and wherein the body includes a chamber having shredding means;
breaking the hinge previously coupling the cap to the body such that the cap is now separate from the body;
placing fresh herbs within the chamber;
positioning the cap so the interior of cap is located opposite the chamber;
guiding the cap into the body;
applying rotational pressure to cause the herbs to come in contact with each of the shredding means to shred the herbs; and
continuing to rotate and shred the herbs until a desired degree of fineness is achieved.

9. The method of claim 8, further comprising pulling the cap away from body after the desired degree of fineness is achieved, storing any residual herbs inside the body, and placing the cap onto the body to keep the residual herbs stored within the body.

10. The method of claim 9, wherein the device further includes a latch mechanism for hinging the cap back onto the body and for keeping the cap held onto the body once the device is no longer in use.

11. The method of claim 8, wherein the hinge includes a first hinge component extending away from the cap, and a second hinge component extending away from the body, wherein the first hinge component and the second hinge component each include breakaway tabs.

12. The method of claim 10, wherein the latch mechanism includes a peg extending from the cap, and wherein the latch mechanism further includes a latch extending away from the body, wherein the latch has a hole configured to receive the peg.

13. The method of claim 8, wherein the cap shredding means include conical shaped protrusions.

14. The method of claim 13, wherein the body shredding means include pentrahedrally shaped protrusions.
